(19) United States
(12) Patent Application Publication
(10) Pub. No.: US 2018/0341098 A1
(43) Pub. Date: Nov. 29, 2018

(54) COMBINED OPTICAL MICROMANIPULATION AND INTERFEROMETRIC TOPOGRAPHY

(71) Applicant: The Regents of the University of California, Oakland, CA (US)

(72) Inventors: Bahman Anvari, Tustin, CA (US); Mohammad Sarshar, Huntington Beach, CA (US)

(21) Appl. No.: 15/771,995

(22) PCT Filed: Oct. 28, 2016
(86) PCT No.: PCT/US16/59560

§ 371 Date: Apr. 27, 2018

Related U.S. Application Data
(60) Provisional application No. 62/248,149, filed on Oct. 29, 2015.

(51) Int. Cl. G02B 21/32; G01B 11/24; G02B 21/36; G02B 21/26; B25J 7/00; G01N 1/28

(52) U.S. Cl. CPC G02B 21/32; G01B 11/24; G01N 1/28; G02B 21/26; B25J 7/00; G02B 21/36

(57) ABSTRACT

Various embodiments disclosed relate to a system. According to various embodiments the present disclosure provides a system. The system includes a movable sample stage configured to receive a sample. The movable sample stage includes a first major surface and a second major surface opposite the first major surface. A portion of the first major surface and the second major surface can be transparent. An excitation light source is aligned with and is in optical communication with the first major surface of the sample stage. A microscope objective is disposed on the second major surface and is substantially aligned with the excitation light source. A laser source is in optical communication with the sample stage. A dichroic mirror is aligned with the microscope objective and is configured to direct light emitted from the laser in a first direction towards the microscope objective

### CROSS-REFERENCE TO RELATED APPLICATION

This application claims the benefit of priority to U.S. Provisional Patent Application Ser. No. 62/248,149 filed Oct. 29, 2015, the disclosures of which are incorporated herein in their entirety by reference.

### STATEMENT OF GOVERNMENT SUPPORT

This invention was made with Government support under Grant No. DC002775 awarded by the National Institute of Health and under Grant No. BES-0522862 awarded by the National Science Foundation. The U.S. Government has certain rights in this invention.

### BACKGROUND

To better understand a nano or micro scale structure or environment it can be helpful to develop an image of the environment as well as ascertain any mechanical properties that the structures may have. Typically the environment must be images and the mechanical properties must be studied individually. This is because typical devices are not configured to perform both functions. Therefore generating images and studying the mechanical properties of the structure or environment can be time consuming and costly.

### SUMMARY OF THE DISCLOSURE

According to various embodiments the present disclosure provides a system. The system includes a movable sample stage configured to receive a sample. The movable sample stage includes a first major surface and a second major surface opposite the first major surface. A portion of the first major surface and the second major surface can be transparent. An excitation light source is aligned with and is in optical communication with the first major surface of the sample stage. A microscope objective is disposed on the second major surface and is substantially aligned with the excitation light source. A laser source is in optical communication with the sample stage. A dichroic mirror is aligned with the microscope objective and is configured to direct light emitted from the laser in a first direction towards the microscope objective. A first detector component adapted to detect movement of an object; and a second detector component configured to generate an image the sample.

According to various embodiments of the disclosure, a method includes trapping a component of a sample. A mechanical property of the sample is measured. The sample is then imaged. Measuring the mechanical property of the sample and imaging the sample are performed substantially simultaneously.

### BRIEF DESCRIPTION OF THE FIGURES

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a schematic diagram of a platform integrating optical tweezers and interferometric quantitative phase microscopy, in accordance with various embodiments.

FIGS. 2A-2D show quantitative phase microscopy images of a microchip.

FIG. 3 shows the quantitative phase image of a tether extracted from a HEK-293 cell

FIGS. 4A-4D show an illustrative example of concurrent optical micromanipulation, force microscopy, and structural metrology during a membrane tether experiment.

FIG. 5 shows a detector readout reading the displacement of the trapped object to determine mechanical properties.

FIG. 6 shows a calibration plot of the optical tweezers.

FIGS. 7A and 7B show a cross section of a tether along its axis versus time, with time plots of tether reaction force and tether mean diameter along its axis.

FIG. 8 shows a time sequence of a tether profile.

FIGS. 9A-9B shows the time sequence of reaction forces and diameters of a tether formed from a cytoskeleton-disrupted HEK293 cell during 14 s of tether elongation followed by 30 s of quantitative observation of tether behavior post elongation

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process,

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

Optical tweezers has emerged as a prominent light-based tool for pico-Newton (pN) force microscopy in mechanobiological studies. However, the efficacy of optical tweezers can be limited in applications where concurrent metrology of the nano-sized structure under interrogation is essential to the quantitative analysis of its mechanical properties and various mechanotransduction events. The inventors have developed an all-optical platform delivering pN force resolution in parallel to ≈30 nm (or better) axial resolution in biological samples by combining optical tweezers with interferometric quantitative phase microscopy. These capabilities allow real-time micromanipulation and label-free measurement of sample's nanostructures and nanomechanical responses, opening avenues to a wide range of new research possibilities and applications in biology.

Optical tweezers (OTs) continue to remain a desired and nondestructive tool in biophysical studies that involve force measurements on the cellular, sub-cellular, and molecular scales. Quantitative mechanobiological studies are relevant to understanding of cellular processes such as morphogenesis, differentiation, cytokinesis, growth, and motility. The inventors utilized OTs to study membrane-based transduction, and membrane-cytoskeleton interactions by extracting membrane nanotubes (tethers) from cells.

While OTs provides excellent resolution in force measurements, sub-diffraction morphological changes in the load-bearing elements are undetectable using conventional microscopy. Super-resolution microscopy (SRM) methods employing fluorescent labels may not be favorable as they impose changes on the molecular structures of the specimen that affect its mechanical behavior. Similarly, scanning probe SRM techniques such as atomic force microscopy (AFM), tip-enhanced near-field optical microscopy, and the recent method of scanning optically trapped spheres for surface imaging may not be suitable for concurrent micromanipulation and wide-filed imaging of the sample. In addition to their poor temporal resolution for wide-field imaging, such techniques may inherently disturb local force fields and may apply additional forces to the sample.

Although electron microscopy in fluids has been made possible, its application to live samples may be limited mainly due to radiation damage, and decreased resolution in imaging depth. Low imaging contrast in addition to complex substrate, sample, and chamber preparations required to integrate electron microscopy with other microscopy modes may further complicate its use in biological studies.

Interferometric quantitative phase microscopy (QPM) offers a method for SRM of transparent and semi-transparent objects in a non-invasive and label-free manner. The sample's thickness, and the mismatch between its refractive index (RI) and that of the surrounding medium result in optical path-length delays that can be resolved at sub-nanometer resolution using QPM. Wide-field SRM at video rates and the ease of integrating QPM methods with other investigative techniques (such as fluorescence microscopy) has led to a growing application of QPM to the functional and structural biological studies.

The inventors disclose herein a platform that combines stiffness-calibrated OTs with an interferometric QPM technique based on Zernike's phase contrast and Gabor's holography. This combined optical micromanipulation and interferometric topography (COMMIT) platform allows simultaneous measurements of pN level forces with nm scale spatial resolution associated with the object under interrogation. Low coherence illumination and common-path interferometry allow for speckle-free imaging at high phase stability.

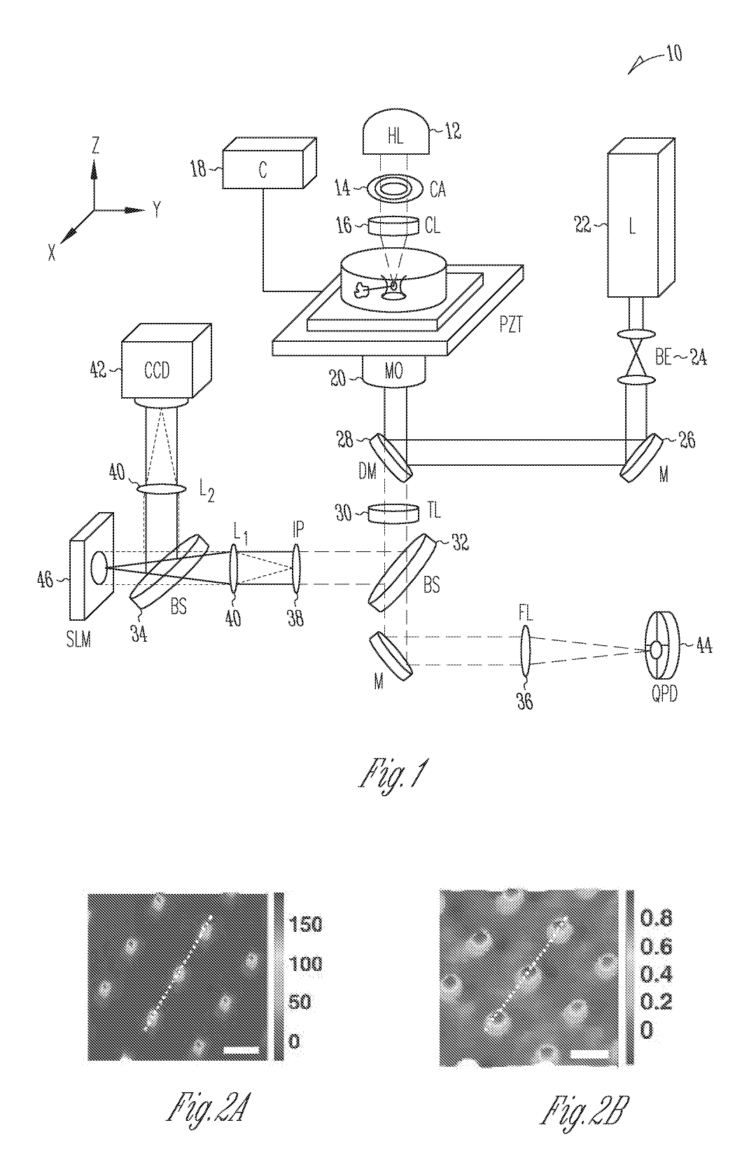

FIG. 1 shows a schematic of the COMMITT platform 10 integrating OTs and interformetric QPM. Platform 10 includes HL: halogen lamp 12, condenser annulus 14 (CA), condenser lens 16 (CL), PZT controller 18 (C), microscope objective 20 (MO), ND:YVO₄ laser 22 (L), beam expander 24 (BE), mirror 26 (M), dichroic mirror 28 (DM), tube lens (TL) 30, first beam splitter (BS) 32, second beam splitter (BS) 34, focusing lens 36 (FL), image plane (IP) 38, polarizers(L₁ and L₂) 40, charge coupled display (CCD) 42, quadrant photodetector (QPD) 44, and spatial light modulator (SLM) 46. In operation, a Nd:YVO₄ laser beam (Prisma 1064-V, Coherent, Santa Clara, Calif.) was expanded and coupled into an inverted microscope (Ti-Eclipse, Nikon Inc., Melville, N.Y.) to form the optical trap. A 100× oil immersion objective lens (N.A. 1.49, Apo-TIRE, Nikon) was used for simultaneous imaging and optical trapping. A piezoelectric stage with 1 nm precision in x, y and z coordinates was used to control the relative position of samples and the optical trap. Sulfate-modified polystyrene microspheres with a mean diameter of 4.2 μm (Molecular probes, Eugene, Oreg.) were used as handles for pulling tethers, and optical probes for force measurements.

The sample was illuminated by a 100 W halogen lamp through a condenser annulus. Light that passes through the sample unscattered (U₀) forms the image of the condenser annulus at the Fourier plane of the achromatic doublet (L₁). A reflective spatial light modulator (SLM) (Hamamatsu Corp., Bridgewater, N.J.) was used to shift the phase of U₀ in four π/2 steps. The unscattered component interferes with the unmodulated scattered field (U₁)to form the sample's image on the detector at the focal plane of the second achromatic doublet (L₂).

An EM-CCD (C9100-13, Hamamatsu) captured the intensity maps of the sample (I₁₋₄) corresponding to the four phase modulations. CCD's exposure time was set to 30.5 ms. To accommodate full re-arrangement of the nematic liquid crystals in the SLM, field delays of 83 ms (SLM response time for a π2 modulation) were used between the phase modulations. Twelve phase shifted images were acquired every second to yield quantitative phase resolved images at 3 fps. To obtain the phase delay map (φ), the inventors first calculated the phase difference between U₀ and U₁ using the four intensity maps:

Δφ=tan ⁻¹[(I₁−I₃)/(I₂−I₄)] (1)

The phase delay map was then calculated as:

φ=tan ⁻¹[β sin(Δφ)/(1+β cos(Δφ))] (2),

where β=|U₁|/|U₀|. The calculated phase delay map is correlated with the sample's thickness along the propagation axis of the light (d_{z}), center wavelength of the illumination (λ=595 nm), and the local differences between the RIs of the sample and the surrounding medium (nₛ and nᵣ, respectively):

$$ϕ = \frac{2 π}{λ} ( {n}_{r} - {n}_{s} ) {d}_{z} \qquad ( 3 )$$

The inventors calibrated the stiffness of the optical trap against viscous drag forces since the trapped particle undergoes large displacements in our experiments. Microspheres were trapped inside Modified Eagle Medium (MEM) at 37° C., and a piezoelectric stage (Physik Instrumente, Waldbronn, Germany) was used to move the trapping medium against the optically trapped particle at various speeds. For the force calibration process, microsphere's displacements from the center of the optical trap were monitored at 10 KHz using a QPD (Pacific Silicon Sensor, Westlake Village, Calif.) in imaging mode, delivering a 10 nm resolution. Viscous drag forces were plotted against microsphere displacements to calculate the OTs stiffness (see Appendix for more details). Sub-pixel particle tracking was used during cell experiments to calculate microsphere displacements in the CCD images at 10 nm spatial resolution.

A custom made microchip and polystyrene nanospheres of two different diameters were used to verify the validity of the topographical results. To fabricate the microchip, a microscope glass coverslip was spin coated with polymethylmethacrylate (PMMA) (MicroChem, Westborough, Mass.) at 4,000 rpm for 30 seconds. After spinning, the chip was transferred to a hot plate and heated to 180° C. for 80 seconds. Arrays of patterns were then etched into the microchip using electron beam lithography (Leo SUPRA 55, Zeiss, Oberkochen, Germany). The resulting patterns have depths ranging between 150 to 190 nm. An area on the chip was selected and imaged using AFM (Smart SPM-I000, AIST-NT Inc., Novato, Calif.) for comparison with the QPM topography results of the same region.

In addition to using the custom made microchip, the inventors validated the system's QPM measurements by imaging polystyrene nanospheres with manufacturer (Molecular Probes, Eugene, Oreg.)-reported mean diameters±standard deviation (SD) of 400±17 nm and 630±16 nm. The nanospheres were dispersed in water, transferred onto a microscope coverslip, and allowed to dry before imaging.

The inventors used the COMMIT platform to simultaneously form, image, and measure the dynamic forces associated with membrane tethers pulled from kidney (HEK-293) cells, as a model nano-structured system. HEK-293 cells were seeded onto glass-bottom petri dishes coated with Poly-L-Lysine 24 hours before the experiments. Cells were cultured at 37° C. and 5% CO₂ in a medium including minimum essential medium (MEM) and 10% fetal bovine serum. Prior to pulling tethers, cells were washed with 1× phosphate buffer saline, and the culture medium was replaced by a mixture of MEM and 4.2 μm microspheres. A microsphere was optically trapped and brought into contact with the membrane of an adhered cell until a surface attachment between the microsphere and the cell membrane was confirmed. The cell was then moved away from the optically trapped particle at 1 μm/s using the piezoelectric stage, extruding a membrane tether.

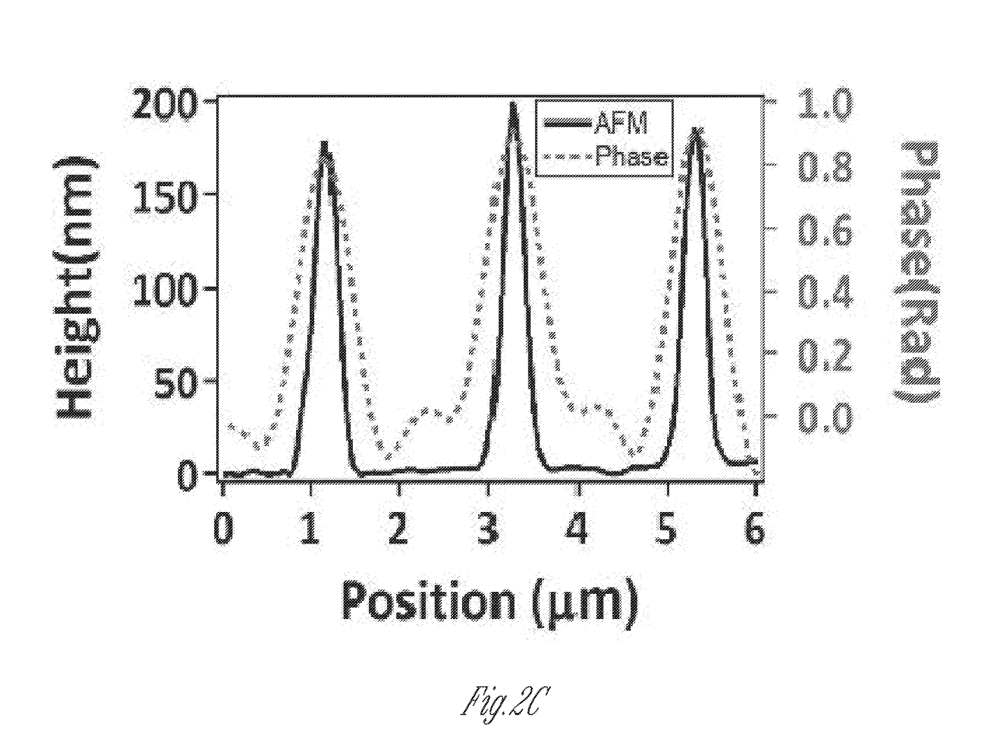

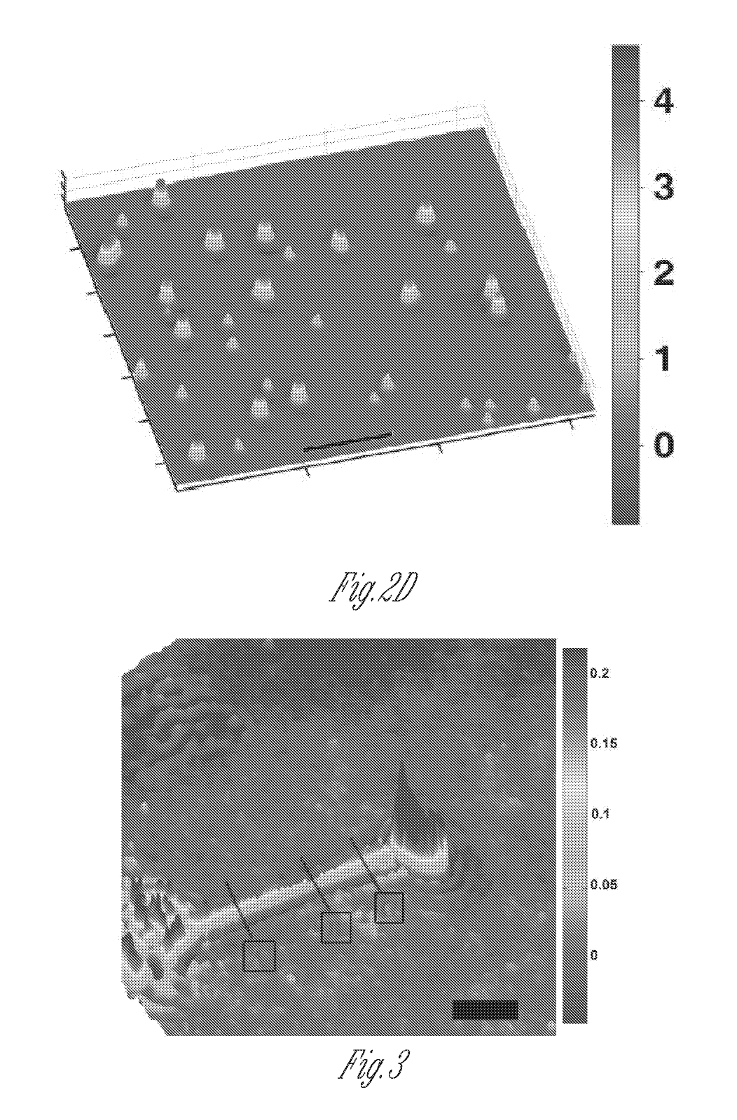

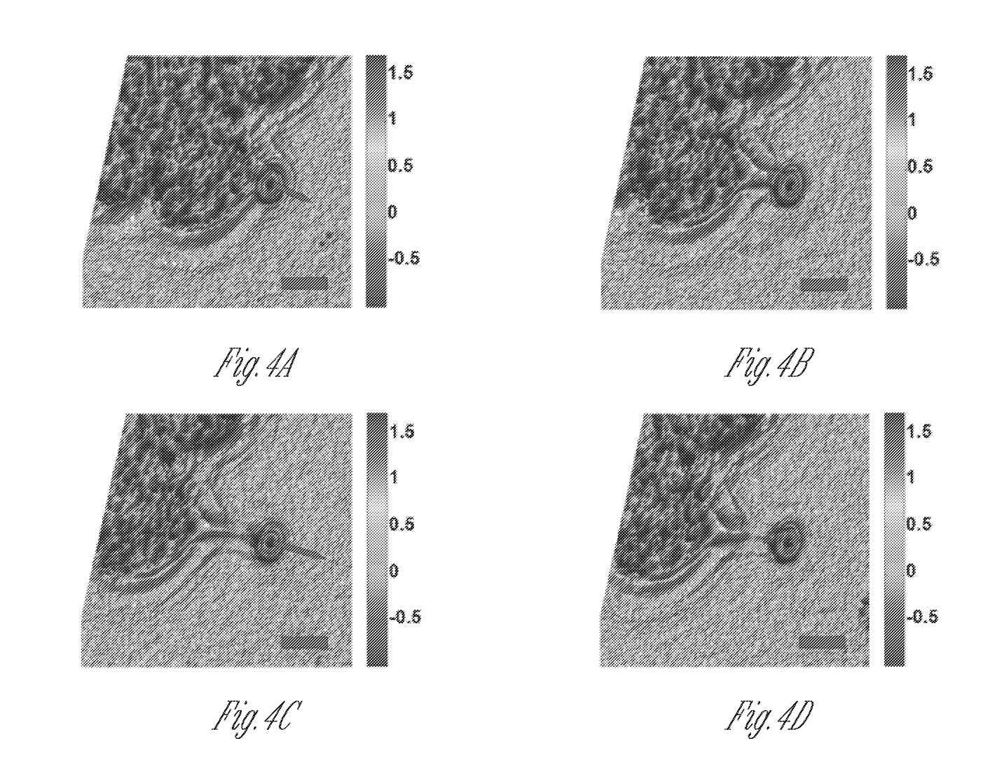

The AFM-based topography and QPM-resolved image of the custom made microchip are shown in FIGS. 2A-C, respectively, and compared with each other in FIG. 2D. While the lateral resolution of the quantitative phase image is diffraction limited, parallel to the direction of light propagation, QPM reported the size of the sub-diffraction structures within ±7.2 nm of the corresponding features measured using AFM. The mean±SD depth of the microchip features were measured as 179±15 nm using AFM and 172±16 nm using QPM. FIG. 2D shows the polystyrene nanospheres resolved by QPM. Assuming n_{polystyrene microsphere}=1.59, the QPM-resolved mean±SD nanosphere diameters of 425±13 nm and 616±16 nm are in good agreement with those reported by the manufacturer.

FIG. 3 shows the quantitative phase image of a tether extracted from a HEK-293 cell using the COMMIT platform. In the absence of experimental methods to verify the nanostructure of cell membrane tethers, mechanical models of tethers have been widely based on the tenet that lipid membrane nanotubes exhibit perfect cylindrical shapes at equilibrium. For the first time, these label-free super resolution images reveal curvatures and diameter changes along the tether axis that are well below the diffraction limit. The curved (catenoid) shape of the tether contour is in agreement with the predictions of recent multi-scale molecular models of bilayer nanotubes.

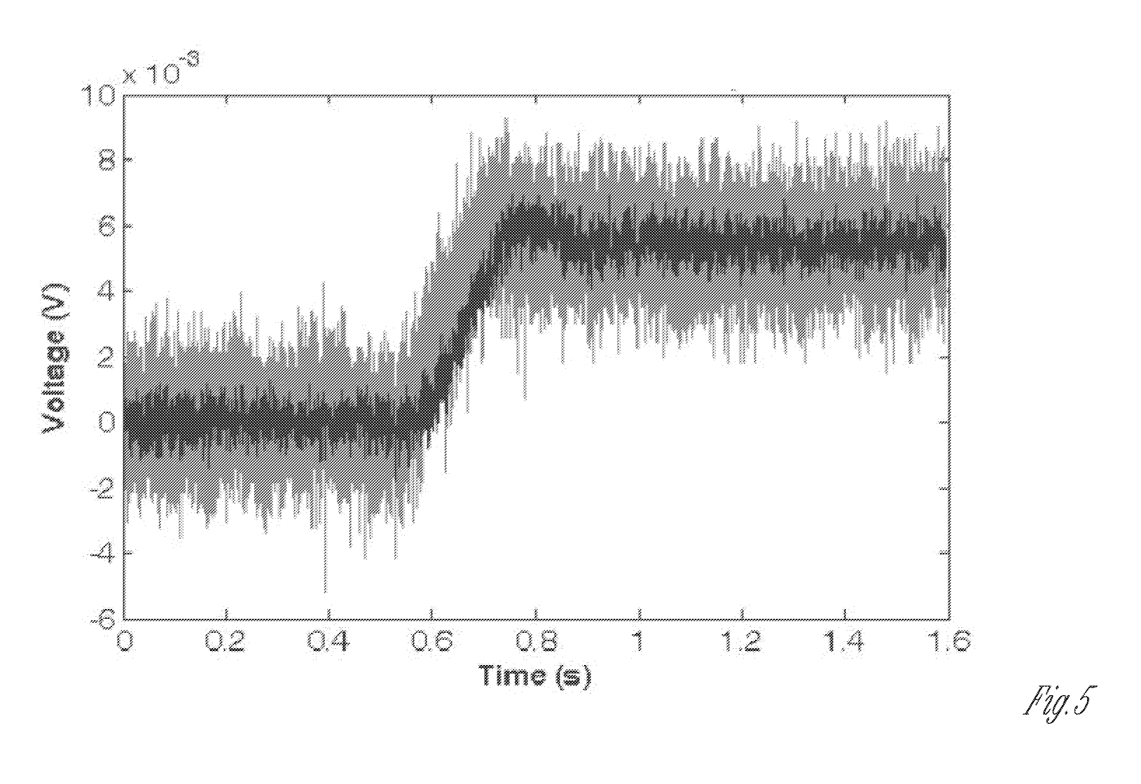

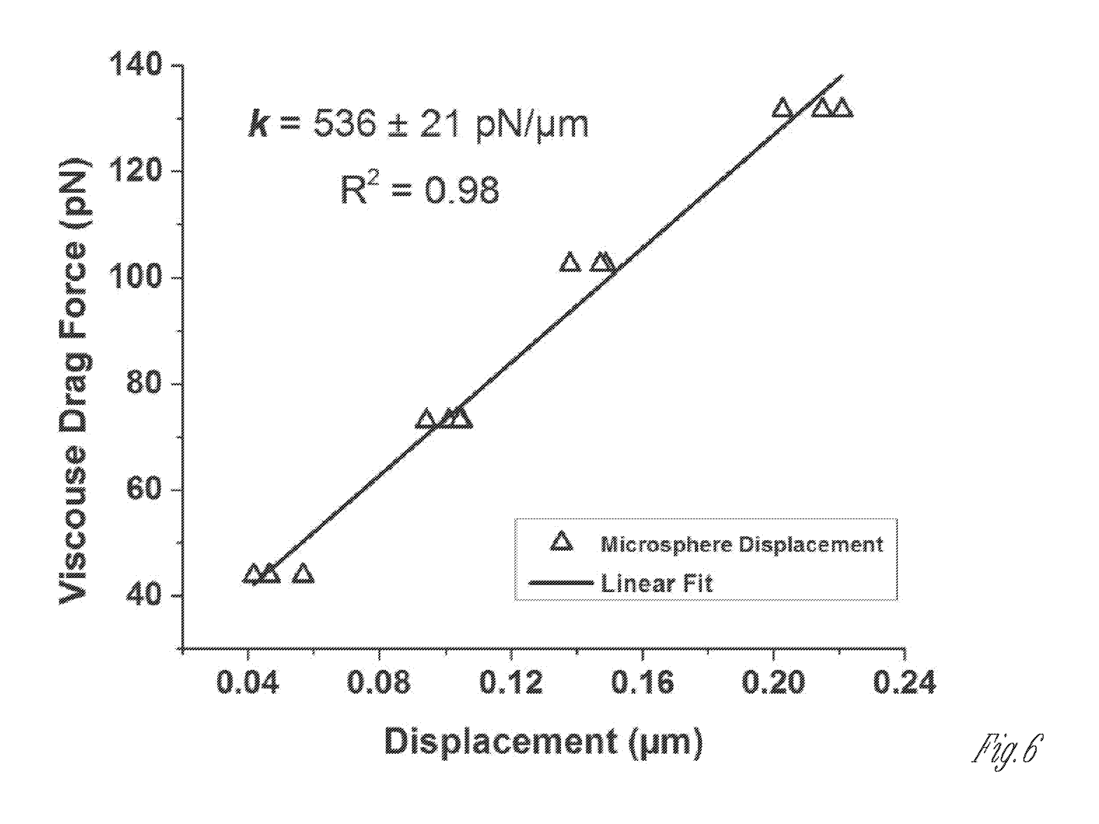

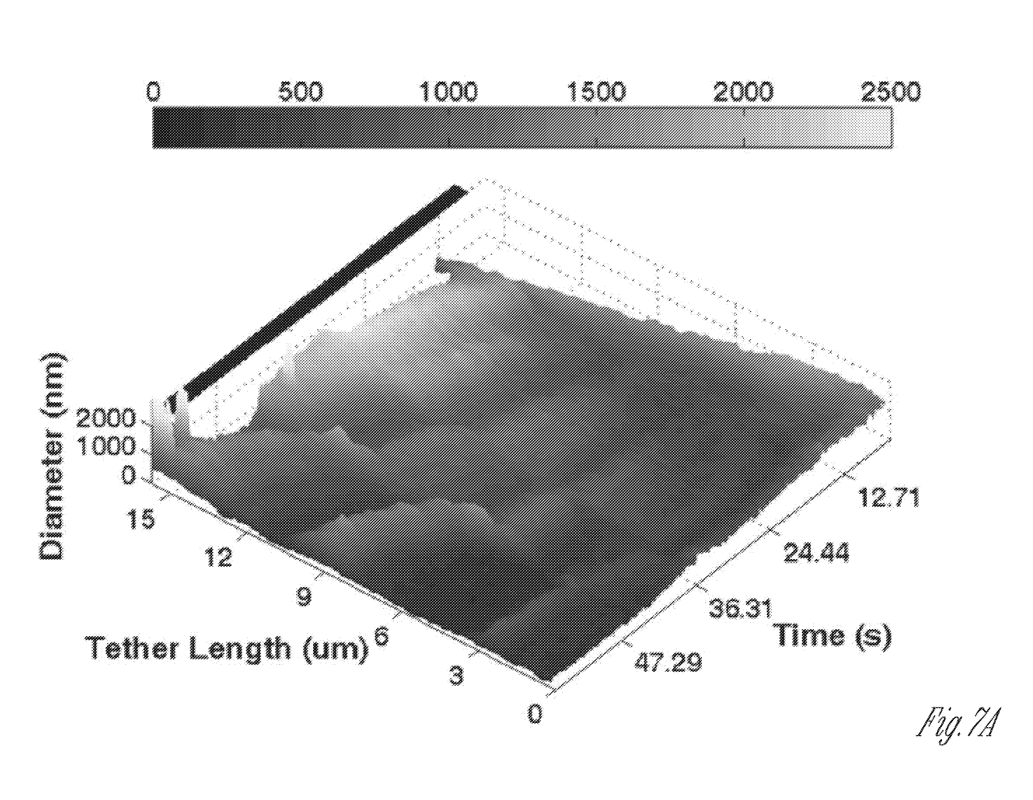

Using the COMMIT platform, the inventors were also able to study the dynamic process of membrane nanotube formation. FIGS. 4A-4D show an illustrative example of concurrent optical micromanipulation, force microscopy, and structural metrology during a membrane tether experiment. An optically trapped 4.2 μm microsphere was used to form a tether by detaching the cell membrane from the underlying cytoskeleton (FIG. 4A). Following the detachment of a patch of membrane from the cytoskeleton, tether reaction force decreases during the elongation interval (FIG. 4B). Membrane tether ruptures in reaction to the increased pulling force (FIG. 4C). Subsequently, lipid bilayer reassembles at the either ruptured end of the tether resulting in a brief reversal of the reaction force direction (FIG. 4D).

The maximum imaging resolution of the QPM method depends on the RI difference between those of the sample (nₛ) and the surrounding medium (n_{media}) (Eq. (3)), and is may be limited by the temporal phase noise of the system (5 mrad in our current setup). The QPM method employed in this study has been previously shown to produce topographical results from graphene structures at sub-nanometer accuracy. In cellular applications, where low RI differences are involved (n_{cell} reported in the range of 1.354 to 1.8 and n_{media}=1.337), the topography resolution of our platform ranges from 11 to 28 nm.

Force-calibrated optical micromanipulation in conjugation with video rate QPM facilitates dynamic measurement of the transient nano-scale mechanical properties of cells and intracellular organelles, by bridging nanomechanical measurements with real-time nanostructural information. Cellular mechanical properties are regarded as highly sensitive markers of disease. QPM conjoined with machine learning algorithms is also being investigated as a marker-free diagnostic tool in histopathology. Therefore, COMMIT can potentially improve the reliability of the histological findings by combining both of these analytical capabilities in one platform. In mechanobiology studies. COMMIT can provide an unprecedented capability for simultaneous induction of precise mechanical stimuli along with quantitative analysis of the mechanical responses, and in-vivo measurement of the resulting sub-diffraction cell shape changes and organelle deformations.

Using this platform Automated assembly of complex nano structures could be made possible using this platform since it offers simultaneous nanometer positioning, fine micro-manipulations, and realtime structural and force feedbacks needed for process control. It could also potentially be used in real time clinical monitoring applications to visualize cells, or some nanostructures label free, and manipulate (push/pull) it and observe the response.

It could also be used in differentiating healthy cells apart from the unhealthy ones (and even the grade of their unhealthiness) by analyzing the mechanical characteristics of the interrogated materials. By high throughput in vivo screening of cells, clinical decisions could be carried out.

The inventors have provided the first demonstration of an experimental platform combining force calibrated OTs and QPM for concurrent optical micromanipulation at nanometer scale, pN force microscopy, and wide-field label-free non-invasive super resolution metrology of the sample. Our experimental platform enables new discoveries in a wide range of mechanobiological studies.

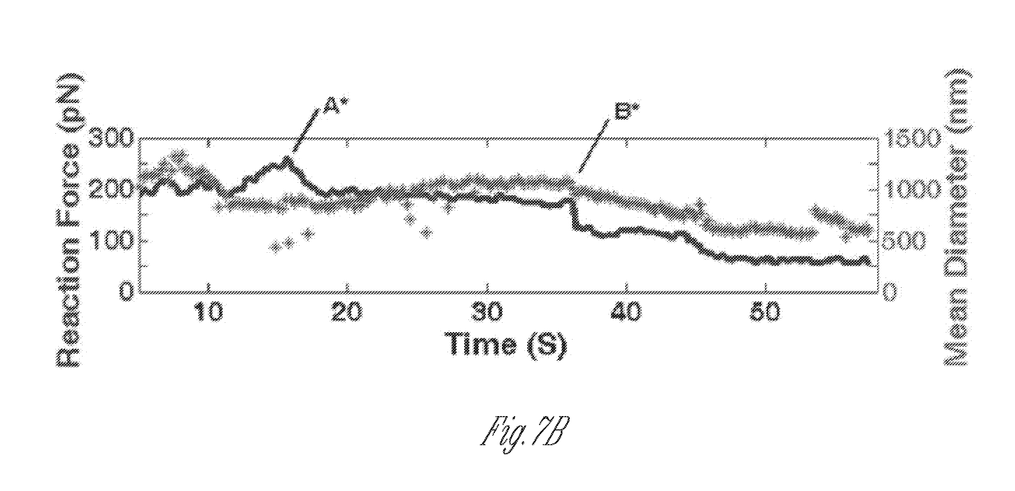

The stiffness of the optical tweezers (OTs) was calibrated against calculated viscous-drag forces applied on an optically-trapped particle by moving the trapping medium against the particle. The trapped particle was imaged onto a quadrant photodetector (QPD) (FIG. 1), and its displacements were tracked using the displacement-calibrated differential voltage readouts of the QPD at 10 KHz. Position standard deviation of a stationary 4.2 μm diameter microsphere was <10 nm as tracked using the QPD (FIG. 5).

The viscous-drag force applied to the trapped microsphere was calculated as:

$${F}_{drag} = \frac{6 πη vr}{1 - \frac{9}{16} ( \frac{r}{h} ) + \frac{1}{8} {( \frac{r}{h} )}^{3} - \frac{45}{256} {( \frac{r}{h} )}^{4} - \frac{1}{16} {( \frac{r}{h} )}^{5}} \qquad ( 4 )$$

where η is the dynamic viscosity of DMEM (1.41 centipoise at 37° C.), v is the fluid velocity induced by the PTZ-controlled displacement of the trapping chamber, r is the radius of the microsphere (2.1 μm), and h is the height of the microsphere from the bottom of the trapping chamber (12 μm). Particle displacements from the center of the optical trap were tracked using the QPD, and plotted against the viscous-drag forces to calculate the OTs' Hookean stiffness (FIG. 6).

The plasma membrane is a key player in vital cellular functions such as motility, growth, and mitosis. Membrane studies by means of forming membrane nanotubes, also called tethers, have given valuable insight into mechanics of plasma membranes, membrane-cytoskeleton interactions, and mechanotransduction. Naturally occurring membrane tethers function in adhesion, cell-cell communication, and transmission of pathogens. Studying membrane tethers allows for quantification of membrane properties including bending modulus, viscosity, and tension, which are mediators and drivers of physiological functions like trafficking, cell motility, and cell division.

Membrane tethers may be extruded through micropipette aspiration, atomic force microscopy, magnetic tweezers, or optical tweezers, with the latter delivering the highest force resolution. As changes in tether diameter and profile often fall below the diffraction limit, conventional microscopy techniques cannot be used to study membrane tether geometry. In the absence of label-free non-invasive microscopy approaches to quantitatively study membrane nanostructures, tether studies mainly focus on the dynamic measurement and analysis of tether reaction forces under various mechanical and chemical manipulation regimes.

By assuming simple cylindrical shapes for tethers, the dynamic tether profile changes that accompany the aforementioned forces have not been extensively studied. the COMMIT (Combined Optical Micro-Manipulation and Interferometric Topography) platform can allow for concurrent optical force microscopy and quantitative imaging of cellular structures at nanometer resolution. The inventors have utilized COMMIT to study the dynamics of normal and cytoskeleton-disrupted human embryonic kidney (HEK293) cell membrane tethers. The inventors have simultaneously formed membrane tethers from normal and cytoskeleton-disrupted cell and measured tether structure and reaction forces.

The setup, calibration, and validation of the COMMIT platform used to form and study the HEK293 cell membrane tethers is described herein with reference to FIG. 1. In brief, a Nd:YVO₄ laser (Prisma 1064-V, Coherent, Santa Clara, Calif.) and a 100× oil immersion objective lens (N.A. 1.49, Apo-TIRF, Nikon Inc., Melville, N.Y.) were used to form the laser tweezers for optical manipulation and force microscopy. The expanded trapping laser beam was coupled into the microscope objective (Ti-Eclipse, Nikon) by a dichroic mirror (680despxr-laser, Chroma Technology Corp, Bellow Falls, Vt.) with 90% transmittance at 470-650 nm, allowing for simultaneous optical trapping and imaging of the sample.

The spatial control of the relative position of the trap and HEK293 cells was achieved using a piezoelectric stage with 1 nm precision in x, y, and z coordinates (PhysikInstrumente, Waldbronn, Germany). Stiffness of the optical trap was calibrated against known viscous drag forces as described in²⁰, with spring constant k=320 pN.μm⁻¹ for 500 mW of laser delivered at the specimen plane.

COMMIT illuminates the sample through a condenser annulus to perform QPI. A 4f configuration is used to spatially separate and later recombine the unscattered (U₀) and scattered (U₁) light fields that pass through the sample (FIG. 8). At the Fourier plane of the first achromatic doublet (L₁), U₀ forms the image of the condenser annulus through which the sample is illuminated. A reflective spatial light modulator (SLM) (LCOS-SLM X10468, Hamamatsu Corp., Bridgewater, N.J.) was used to overlay a phase shift mask with the image of the condenser annulus, creating four π/2 phase modulated states of the reflected U₀ field (M₁₋₄) with respect to the reflected U₁. The two fields interfere at the focal plane of the second achromatic doublet (L₂) to form four intensity maps of the sample image (I₁₋₄) corresponding to the four phase modulations.

The intensity maps I₁₋₄ were recorded using an EM-CCD camera (C9100-13, Hamamatsu) at 35.8 fps with the exposure time of 28 ms. Knowing the mismatch between the refractive indices of the sample and the surrounding medium (nₛ and nᵣ, respectively), the optical thickness of the sample along the propagation axis of the light (d_{z}) can be calculated from the phase delay maps of the sample. The QPI rate in this scheme is limited by the response delay (transitioning time when switching between two separate phase modulations) of the SLM. A survey of current commercially available SLMs reveal that almost all SLMs providing full 2π phase modulation over the visible wavelengths operate at 60 Hz refresh rate, with the actual phase response delays being slower than their electronic refresh rate. For example, the response times of our SLM for different switching possibilities between the M₁₋₄ states range from 25 ms to 100 ms.

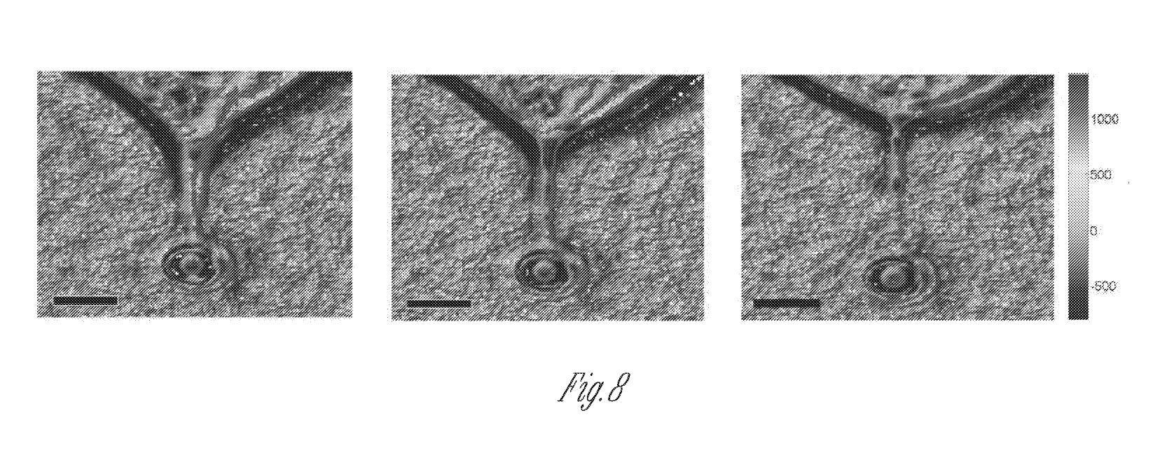

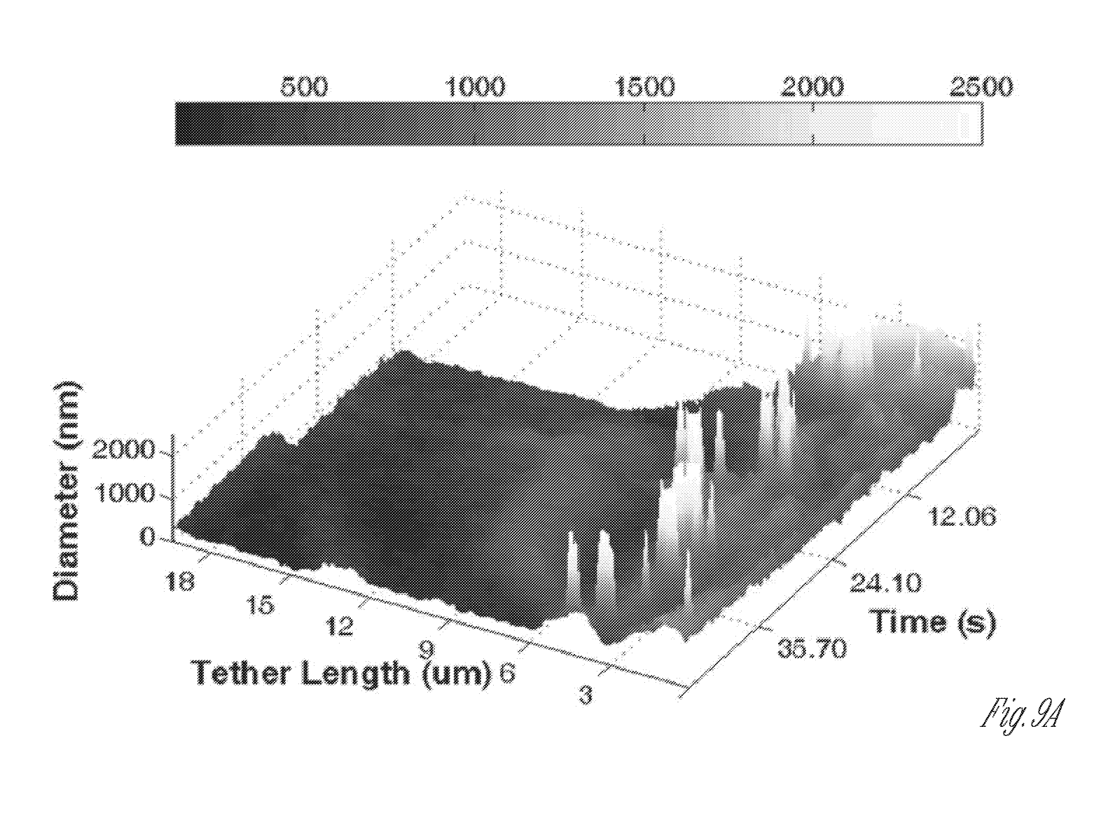

For this study we improved the previously reported 3 fps QPI rate of the COMMIT platform by changing the pattern of phase modulations. A mirrored pattern was used to decrease modulations required for resolving two QPIs from 8 to 6 (FIG. 7A). Additionally, the arrangement of the subsequently modulated states was optimized to minimize the accumulative response delay within each repeating phase modulation cycle. A 30 ms delay between the modulations was added to the calculated response delay of each modulation to ensure that at least one image of the modulated state after the phase transition period is collected. Given the unequal response delays for each modulation and an independent image acquisition platform, time intervals between the four recorded modulated states needed to resolve one QPI may vary. A MATLAB™ (The MathWorks, Natick, Mass.) routine was developed to analyze the intensity maps acquired by the CCD and separate M₁₋₄ states for subsequent phase calculations. Analysis of the timestamps of the resolved QPIs reveals mean±standard deviation intervals of 0.23±0.05 s between the QPI frames, suggestive of a 45% improvement over the last reported QPI acquisition rate.

HEK293 cells were seeded onto glass-bottom poly-d-lysine coated petri dishes in a medium made of minimum essential medium (MEM), 10% fetal bovine serum, and 1% penicillin. Cells were cultured at 37° C. and 5% CO2 for 36 hours prior to the experiments. To disrupt cell cytoskeletons, we incubated cells for 10 minutes with Latrunculin A (EDM Millipore, Temecula, Calif.) which prevents polymerization of actin monomers.²¹ Latrunculin A was dissolved in DMSO and added to MEM to a final concentration of 0.24 μM while the DMSO in the final media remained under 0.05%. The Latrunculin A concentration and incubation time were chosen such that partial disruption of cytoskeleton is achieved, preserving the ability of cells to linger themselves to the substrate through focal adhesion points during membrane tethering experiments.

Sulfate-modified polystyrene beads with 4.2 μm diameter (Molecular probes, Eugene, Oreg.) were optically trapped in MEM and brought into contact with the cell membrane as handles for optical micromanipulation. After a surface adhesion was established between the trapped bead and cell membrane, a tether was formed by moving the cell away from the trapped bead at the speed of 1 μm/s by the piezo electric stage. The inventors dynamically measured tether reaction forces and axial profiles under normal and cytoskeleton disrupted states.

FIGS. 7A and 7B show the time sequence of reaction forces and diameters of a tether formed from a cytoskeleton-intact HEK293 cell during 15 s of tether elongation followed by 45 s of quantitative observation of tether behavior post elongation. FIG. 7A shows the cross section of the tether along its axis versus time, with time plots of tether reaction force and tether mean diameter along its axis presented in FIG. 7B.

Tether reaction force remains high (>200 pN) dining the elongation interval with the highest values reached at the end of the elongation (260 pN at 15.6 s, marked A* on FIG. 7A). Tether diameter changes in this interval with the highest values measured when the bead and cell are less than 8 μm apart (1100 nm). Following this point, tether mean diameter decays (tether thins) with a time constant of about 3 s to 850 nm, concurrent with a decrease in the reaction force (8-11 s). After the tether mean diameter reaches a plateau, tether reaction forces start to grow with the tether length (11-15 s). The tether profile in this period is smooth and uniform along the length of the tether with smaller diameters towards the bead and increasing diameters at the base of the tether near the cell body.

After tether elongation stops, the tether force decays with a time constant of 7.7 s reaching a value of about 200 pN, holding the tensing through a slow linear decrease to 170 pN while the mean diameter of tether gradually increases. Tether contour along its axis starts to transitions away from the smooth regime and develops regions of higher diameter along the axis, with higher diameters maintained at the base of the tether. At t=35 s (marked B* on FIG. 7B), a sudden drop follows a local peak in tether reaction force (from 180 pN to about 115 pN), followed by a gradual decrease in tether mean diameter at this constant force (36-44 s). A third decay in tether reaction force with a time constant of 16.9 s is seen as the tether thins on both ends while regions of much higher diameter are formed along the tether axis, maintaining an almost constant mean tether diameter in this interval. Concurrent with these events, cell begins a process of retracting its walls at the base of the tether and reshaping itself (35-53 s, FIG. 8).

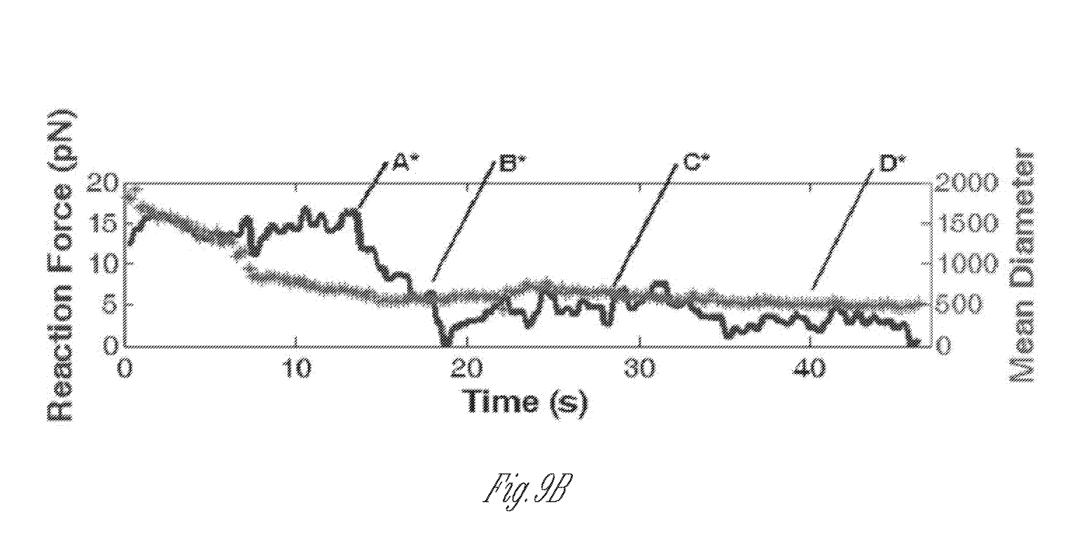

FIG. 9 shows the time sequence of reaction forces and diameters of a tether formed from a cytoskeleton-disrupted HEK293 cell during 14 s of tether elongation followed by 30 s of quantitative observation of tether behavior post elongation. FIG. 9A shows the cross section of the tether along its axis versus time, with time plots of tether reaction force and tether mean diameter along its axis presented in FIG. 9B.

The tether is extruded at low force (15 pN) which remains at the same level through the tether elongation interval (at 15 s, marked A* on FIG. 9B). The tether is extruded at an initial diameter of 1900 nm. Mean diameter of the tether drops linearly independent of the elongation regime to its equilibrium value of 500 nm. Contrary to the cytoskeleton-intact case where the tether profile had smaller diameters towards the bead and increased diameters near the cell, here tether diameters along the axis range from 1000 nm adjacent to the bead to 250 nm towards the cell body.

Tether reaction force drops to 5 pN as the tether mean diameter drops to its mean equilibrium value (14-17 s). The cell wall is retracted at the tether extraction site at the times marked B*, C*, and D* on FIG. 9B, producing negligible changes in the magnitudes of tether reaction force or tether mean diameter. However, the wall retractions are followed by changes in the tether contour and the locations of regions with higher diameters along the tether axis.

The tension in the tether membrane (σₜ) is the sum of cell membrane tension (σ_{c}) and the work required for tether extrusion (W_{c}, the total work of changing membrane curvatures, linker detachments, and rearrangement of molecules). Tether diameter is related to the tension in the tether:

$${d}_{t} \text{/} 2 = \sqrt{\frac{{M}_{B}}{2 {σ}_{t}}} , \qquad ( 5 )$$

where M_{B} is the effective bending modulus of the membrane. The higher tether diameters at the beginning of tether extrusion in the cytoskeleton-disrupted case are due to the lower tension in the cell membrane and lower extrusion work in the absence of an intact cytoskeleton. The smaller extrusion diameter of the tether in the cytoskeleton-intact case is suggestive of the effect of cytoskeleton in generating and maintaining tension in the membranes of both the cell and the tether.

Following tether extrusion and introduction of a tension difference between cell and tether membranes, two opposite membrane flows begin affecting the tether diameter: a slow Marangoni flow of membrane towards the area with higher tension to alleviate the lower membrane density; and a fast Poiseuille flow as a result of Laplace pressures towards the area with lower tension. The narrowing of the tether along its axis that immediately follows the separation of bead from the cell body in both cases can be described by the Poiseuille flow. In the cytoskeleton-intact case, QPI-resolved tether contours suggest that this flow depletes tether from its excess membrane in this interval, resulting in the growth-dependent increase in the tether reaction force until the end of elongation. Upon ending of the elongation interval, tether force relaxes to its rate-invariant magnitude with a time constant of 7.7 s, which is in agreement with previously reported data for similar cases.

The slow effects of Marangoni flow are seen after the decay of the tether reaction force. The gradual increase in the tether mean diameter and decrease in the reaction force are indicative of decreased tether tension as a result of Marangoni flow. This hypothesis is supported by the QPI results showing the onset of membrane crumpling along the tether for establishing local mechanical equilibrium. Recently proposed a model in which the sharp membrane curvature at the base of the tether acts as a barrier between the two membrane states with higher and lower density, impeding the Marangoni flow. QPI-resolved profiles of the tether from the cytoskeleton-intact cell show a high tether diameter maintained adjacent to the cell body through this relaxation period. This tether contour effectively reduces the sharp curvatures that would otherwise inhibit tether tension relaxation and the subsequent tether diameter increase. The disclosed results provide the first experimental evidence of cell's selective behavior in facilitating Morongoni flow for adjusting the tension in its tether, by maintaining a decreased membrane curvature at the tether base.

The gradual relaxation of the tension in the tether extracted from cytoskeleton-intact cell is accompanied by an increase in its diameter initiated at the base of the tether and propagating along its axis (FIG. 9). While tether reaction force does not show significant changes in this period, analysis of the QPI results shows a clear intrusion of cytoplasmic matter into the tether. The sudden drop in tether reaction force seen at point B* in FIG. 9B is characteristic of breakage of cytoskeletal filaments under tensile stress. While tether mean diameter shows small changes following this drop in force, QPI images reveal substantial changes in tether profile. Tether diameter drops at both ends, while tether contents accumulate in regions of higher diameter formed along the axis of the tether. The smaller radius of these crumbles compared to that of the cell indicates that place pressures should move tether contents towards the cell body. However, tether reaction force and the location of the crumbles along the tether remained the same for the next 8 s, suggestive of local adhesions between the tether membrane and its cytoplasmic content. During this time, the membrane curvature at the base of the tether changed as the cell begins to retract its wall.

Force relaxation of the tether formed from the cytoskeleton-intact cell was initiated by a local deformation at the base of the tether. As evidenced by the QPI results, this decay is accompanied by a shift of the tether contents towards the cell body (FIG. 9A). Local deformations at the base of the tether gave rise to tether profile changes resembling a peristaltic motion although mean tether diameter does not reflect these changes as multiple foci of higher diameter moved along the tether. By the end of this interval, tether reaction force relaxes to its equilibrium value of about 40 pN and tether mean diameter decreases to 500 nm.

In the cytoskeleton-disrupted case, the low and constant reaction force during the elongation interval is evidence of free flow of membrane into the tether from the unbound membrane reservoir. QPI reveals that in the absence of a significant membrane tension gradient at the beginning of tether extrusion, membrane moves towards both ends of the tether as a result of the Poiseuille flow. This effect leads to tether membrane accumulation at the bead attachment site, contrary to the tether extruded from a cytoskeleton-intact cell. As the tether is elongated without the mediating role of cytoskeleton in regulating membrane tensions, the tether maintains its highest diameter at the bead site while place pressures keep the diameter of the tether along its body at the equilibrium value (280-350 nm),

In the cytoskeleton-disrupted case, tether reaction forces decrease to almost zero after elongation stops, as the membrane continues to flow into the tether maintaining its total tension homogeneous with the cell body. At this stage with reaction forces fluctuating <6 pN and no functional evidence of cytoskeletal involvement, the cell wall is retracted at the tether extraction site at time intervals of ˜10 s (points B*, C*, and D* on FIG. 9B). Negligible effect from these attempts is detectable in time profiles of tether reaction force and mean diameter. However, similar to the cytoskeleton-intact case, QPI revealed peristaltic-like changes along the tether axis as a result of local curvature changes generated at the base of the tether. Even at the absence of an active cytoskeleton, low energy local modulation in lipid density or diameter at the base of the tether allows the cell to use membrane's viscoelastic properties to introduce a shape change in the tether. This shape change can in turn invoke a secondary flow (such as Poiseuille flow), resulting in the transfer of matter along the tether at little energetic cost to the cell.

Cell uses the membrane's tendency to keep a homogeneous total tension for sensing its environment far from the cell body without needing to rely on the slow and energy intensive rearrangement of its cytoskeleton. Similarly, by controlling the membrane tension, cell can apply forces send mechanically-mediated signals) where its cytoskeleton is not present. Cellular functions from motility and spreading to the polymerization rate of cytoskeletal filaments in tethers are regulated via membrane tension. We reviewed an example of how the cell uses its cytoskeleton to control the tension in its membrane, regulating the shape of its tether and promoting the intrusion of cytoskeleton inside the tether. Cells make and break multiple tethers while moving and communicating with their environment. They maintain both cytoskeleton-permeated and cytoskeleton-devoid tethers for reasons such as controlling their rate of motility and contact area. In addition to discussing the role of cytoskeleton in membrane tension maintenance, the inventors also disclose the ability of cell to induce shape changes in its protrusions devoid of functioning cytoskeleton.

Cellular tethers are complex nanostructures exhibiting active behaviors different than those of bilayer tethers extruded from vesicles. As such, negligence to quantify the nanostructure of the tether by assuming it as a cylindrical structure with a mean diameter can lead to misinterpretation of the experimental data. The inventors used COMMIT to study the dynamics of membrane tethers extruded from HEK293 cells with intact and disrupted cytoskeletons. Combined optical force microscopy and super resolution QPI allowed the inventors to dynamically quantify both nanomechanical forces and nanostructures of the membrane tethers during the experiments. The inventors made the first observation of cell's active maintenance of low membrane curvature at the base of the tether to facilitate tension relaxation by the Marangoni flow. Using QPI we were also able to show that the cell can sense tensions and induce functional shape changes in the tether even in the absence of cytoskeleton. The experimental data made accessible through COMMIT can be used for dynamic mechanical, structural, and functional modeling to add new insights into every biomechanical phenomenon involving sub-diffraction shape changes.

The following exemplary embodiments are provided, the numbering of which is not to be construed as designating levels of importance:

Embodiment 1 provides a system comprising:
a movable sample stage configured to receive a sample comprising:
   a first major surface;
   a second major surface opposite the first major surface, wherein a portion of the first major surface and the second major surface are transparent;
an excitation light source aligned with and in optical communication with the first major surface of the sample stage;
a microscope objective disposed on the second major surface and substantially aligned with the excitation light source;
a laser source in optical communication with the sample stage;
dichroic mirror aligned with the microscope objective and configured to direct light emitted from the laser in a first direction towards the microscope objective;
a first detector component adapted to detect movement of a component of the sample; and
a second detector component configured to generate an image the sample.

Embodiment 2 provides the system of Embodiment 1, further comprising:
a first beam splitter aligned with the microscope objective and adapted to receive light from the microscope objective and split the light into a first portion and a second portion.

Embodiment 3 provides the system of Embodiment 2, wherein the first portion of light is received by the first detector component and the second portion of light is received by the second detector component.

Embodiment 4 provides the system of any one of Embodiments 2 or 3, wherein the light received by the first beam splitter is a fluorescent emission, scattered light, unscattered light, or combinations thereof.

Embodiment 5 provides the system of any one of Embodiments 1-4, wherein the first detector component comprises a quadrant photodetector.

Embodiment 6 provides the system of any one of Embodiments 1-5, wherein the second detector component comprises:
a spatial light modulator; and
a charge coupled device camera.

Embodiment 7 provides the system of Embodiment 6, further comprising:
a second beam splitter in optical communication with the first beam splitter and configured to split the second portion of light into a third portion of light and a fourth portion of light.

Embodiment 8 provides the system of any one of Embodiments 6 or 7, wherein the spatial light modulator is adapted to receive the third portion of light and the charge coupled device is adapted to receive the fourth portion of light.

Embodiment 9 provides the system of any one of Embodiments 1-8, wherein the excitation light source is a halogen lamp.

Embodiment 10 provides the system of any one of Embodiments 1-9, wherein the laser component is a Nd:YVO₄ laser.

Embodiment 11 provides the system of any one of Embodiments 1-10, wherein the movable sample stage is a piezoelectric stage.

Embodiment 12 provides the system of any one of Embodiments 1-11, wherein the sample is a biological sample, a microparticle, or a combination thereof.

Embodiment 13 provides the system of Embodiment 12, wherein the biological sample includes a cell.

Embodiment 14 provides the system of any one of Embodiments 12 or 13, further comprising a tether between the cell and the microparticle.

Embodiment 15 provides the system of any one of Embodiments 12-14, wherein the microparticle includes a fluorescent tag adapted to emit a fluorescent signal that is received by the first detector component.

Embodiment 16 provides a method comprising:
trapping a component of a sample;
measuring a mechanical property of the sample; and
imaging the sample, wherein measuring the mechanical property of the sample and imaging the sample are performed substantially simultaneously.

Embodiment 17 provides the method of Embodiment 16, wherein trapping the component comprises:
emitting light from a laser; and
contacting the component with light emitted from a laser.

Embodiment 18 provides the method of any one of Embodiments 16 or 17, wherein measuring the mechanical property of the sample comprises:
displacing the component of the sample from a first location to a second location; and
detecting the displacement.

Embodiment 19 provides the method of any one of Embodiments16-18, wherein the displacement is detected by a quadrant photodetector

Embodiment 20 provides the method of any one of Embodiments 16-19, wherein imaging the sample comprises:
emitting light from a light source aligned with the sample;
contacting the sample with the emitted light;
generating scattered light and unscattered light; and
collecting the scattered light and unscattered light.

Embodiment 21 provides the method of Embodiment 20, wherein the unscattered light is phase-modulated by a spatial light modulator.

Embodiment 22 provides the method of any one of Embodiments 20 or 21, wherein the scattered light is collected by a charge coupled device camera.

Embodiment 23 provides the method of any one of Embodiments 20-22, further comprising:
forming an intensity map from the interference of the unscattered and scattered light at four different phases
Embodiment 24 provides the method of any one of Embodiments 16-23, wherein the component of the sample is a microsphere, a nanostructure, a cell or combinations thereof.
Embodiment 25 provides the method of any one of Embodiments 16-24 further comprising:
   trapping a second component of the sample; and
   displacing the second component,

Embodiment 26 provides the method of Embodiment 25 further comprising:
determining a mechanical property of the second component.

What is claimed is:

1. A system comprising:
a movable sample stage configured to receive a sample comprising:
a first major surface;
a second major surface opposite the first major surface, wherein a portion of the first major surface and the second major surface are transparent;
an excitation light source aligned with and in optical communication with the first major surface of the sample stage;
a microscope objective disposed on the second major surface and substantially aligned with the excitation light source;
a laser source in optical communication with the sample stage;
a dichroic mirror aligned with the microscope objective and configured to direct light emitted from the laser in a first direction towards the microscope objective;
a first detector component adapted to detect movement of a component of the sample; and
a second detector component configured to generate an image the sample.

2. The system of claim 1, further comprising:
a first beam splitter aligned with the microscope objective and adapted to receive light from the microscope objective and split the light into a first portion and a second portion.

3. The system of claim 2, wherein the first portion of light is received by the first detector component and the second portion of light is received by the second detector component.

4. The system of claim 2, wherein the light received by the first beam splitter is a fluorescent emission, scattered light, unscattered light, or combinations thereof.

5. The system of claim 1, wherein the first detector component comprises a quadrant photodetector.

6. The system of claim 1, wherein the second detector component comprises:
a spatial light modulator; and
a charge coupled device camera.

7. The system of claim 6, further comprising:
a second beam splitter in optical communication with the first beam splitter and configured to split the second portion of light into a third portion of light and a fourth portion of light.

8. The system of claim 7, wherein the spatial light modulator is adapted to receive the third portion of light and the charge coupled device is adapted to receive the fourth portion of light.

9. The system of claim 1, wherein the excitation light source is a halogen lamp.

10. The system of claim 1, wherein the laser component is a Nd:YVO₄ laser.

11. The system of claim 1, wherein the movable sample stage is a piezoelectric stage.

12. The system of claim 1, wherein the sample is a biological sample, a microparticle, or a combination thereof.

13. The system of claim 12, wherein the biological sample includes a cell.

14. The system of claim 13, further comprising a tether between the cell and the microparticle.

15. The system of claim 12, wherein the microparticle includes a fluorescent tag adapted to emit a fluorescent signal that is received by the first detector component.

16. A method comprising:
trapping a component of a sample;
measuring a mechanical property of the sample; and
imaging the sample, wherein measuring the mechanical property of the sample and imaging the sample are performed substantially simultaneously.

17. The method of claim 16, wherein trapping the component comprises:
emitting light from a laser; and
contacting the component with light emitted from a laser.

18. The method of claim 16, wherein measuring the mechanical property of the sample comprises:
displacing the component of the sample from a first location to a second location; and
detecting the displacement.

19. The method of claim 18, wherein the displacement is detected by a quadrant photodetector

20. The method of claim 16, wherein imaging the sample comprises:
emitting light from a light source aligned with the sample;
contacting the sample with the emitted light;
generating scattered light and unscattered light; and
collecting the scattered light and unscattered light.

21. The method of claim 20, wherein the unscattered light is phase-modulated by a spatial light modulator.

22. The method of claim 21, wherein the scattered light is collected by a charge coupled device camera.

23. The method of claim 20, further comprising:
forming an intensity map from the interference of the unscattered and scattered light at four different phases

24. The method of claim 16, wherein the component of the sample is a microsphere, a nanostructure, a cell or combinations thereof.

25. The method of claim 16, further comprising:
trapping a second component of the sample; and
displacing the second component.

26. The method of claim 25, further comprising:
determining a mechanical property of the second component.
